(19) United States
(12) Patent Application Publication
(10) Pub. No.: US 2015/0270978 A1
(43) Pub. Date: Sep. 24, 2015

(54) METHOD AND APPARATUS FOR DATA REPAIR IN A DATA COMMUNICATION NETWORK

(71) Applicant: Telefonaktiebolaget L M Ericsson (publ), Stockholm (SE)

(72) Inventors: David SHRADER, Wilton Manors, FL (US); Thorsten LOHMAR, Aachen (DE); Lars Lövsén, Goteborg (SE); Michael John SLSSINGAR, Skarholmen (SE)

(21) Appl. No.: 14/220,841

(22) Filed: Mar. 20, 2014

(51) Int. Cl. H04L 12/14; H04L 12/26; H04L 1/16

(52) U.S. Cl. CPC H04L 12/1407; H04L 1/16; H04L 43/0847

(57) ABSTRACT

The present invention relates to a method, media service controller and computer program product for data repair in a data communication network.

The method includes media service controller receiving a data repair request including a data identifier from a user device for establishing a data repair session for the data and finding a content provider identity based on the data identifier received with the data repair request message. The method further includes sending an authorization request including the content provider identity and a flow description to a policy rules function and in response to an authorization response from the policy rules function continuing the data repair session by commencing the data repair data transmission.

### TECHNICAL FIELD

The present invention relates to a method, media service controller and computer program product for data repair in a data communication network.

### BACKGROUND

Multimedia Broadcast and Multicast Services, MBMS, is a broadcasting service offered via cellular networks.

MBMS is a point-to-multipoint service in which data is transmitted from a single source entity to multiple recipients. Transmitting the same data to multiple recipients allows network resources to be shared. The MBMS bearer service offers two modes, Broadcast Mode and Multicast Mode.

Broadcast Mode is supported for Evolved Packet Subsystem, EPS, and General Packet Radio Service, GPRS, and Multicast Mode is supported for GPRS. MBMS for EPS supports Evolved UMTS Terrestrial Radio Access Network, E-UTRAN and UTRAN. MBMS for GPRS supports UTRAN and GSM EDGE Radio Access Network, GERAN.

MBMS architecture enables the efficient usage of radio-network and core-network resources, with an emphasis on radio interface efficiency.

MBMS is realized by the addition of a number of new capabilities to existing functional entities of the 3GPP architecture and by addition of a number of new functional entities.

Enhanced MBMS, eMBMS, is used to denominate MBMS service in Evolved Packet Systems including Evolved Universal Terrestrial Radio Access Network, E-UTRAN, for Long Term Evolution, LTE, cellular networks and UTRAN for e.g. Universal Mobile Telecommunications System, UMTS, cellular networks.

Two delivery methods are defined—the download delivery method and the streaming delivery method. MBMS delivery methods make use of MBMS bearers for content delivery but may also use associated procedures such as a File Repair Procedure.

Associated delivery procedures describe general procedures, which start before, during or after the MBMS data transmission phase. They provide auxiliary features to MBMS user services in addition, and in association with MBMS delivery methods and their sessions.

MBMS file download can be used to deliver an arbitrary number of data files from a single source to many receivers. MBMS Download may use the File Transport over Unidirectional Transport, FLUTE, protocol defined in RFC 3926 by the Internet Engineering Task Force, IETF, for file delivery. FLUTE is designed for massive file delivery over unidirectional links such as for digital broadcasts.

After an MBMS bearer is established, a Broadcast Multicast-Service Centre, BM-SC, starts transmitting or broadcasting the actual MBMS data. The BM-SC can send one or more files using MBMS. All files require an entry in the FLUTE File Delivery Table, FDT, which are provided using FLUTE FDT Instances. The receiving client that receives the broadcast or multicast is called a MBMS client or a User Equipment, UE.

MBMS makes use of Forward Error Correction, FEC, in order for the UE to be able to repair a certain amount of errors that has occurred during the MBMS transmission or session. However, in case there are too many errors, the UE may not be capable of recovering the received data and must instead request a file repair procedure.

The file repair procedure is defined in 3GPP TS 26.346 V12.0.0 paragraph 9.3. The purpose of the File Repair Procedure is to repair lost or corrupted file fragments from the MBMS download data transmission. The principle to protect network resources is to spread the file repair request load in time and across multiple servers. The MBMS client identifies the end of transmission of files or sessions and identifies the missing data from an MBMS download. The client then calculates a random back-off time and selects a file repair server randomly out of a list. Then, it sends a repair request message to the selected file repair server at the calculated time.

When a MBMS download session of repair data is configured in the associated delivery descriptions, a MBMS client should wait for repair data in the defined MBMS download session on its MBMS bearer—except where the UE is prevented from doing so due to limited simultaneous context activation capability.

Then the file repair server responds with a repair response message either containing the requested data, redirecting the client to an MBMS download session, redirecting the client to another server, or alternatively, describing an error case. The BM-SC may also send the repair data on a MBMS bearer (possibly the same MBMS bearer as the original download) as a function of the repair process.

The random distribution, in time, of repair request messages enhances system scalability to the total number of such messages the system can handle without failure.

Further, according to 3GPP TS 23.246 v12.0.0 chapter 10.1 MBMS shall collect charging information about the transmission of MBMS broadcast or multicast data that are provided by content or service providers (e.g. 3rd parties) in order to enable billing of broadcast and multicast content or service providers.

In the current art, a Charge Detail Record (CDR) is generated by the BM-SC for a specific broadcast event. This CDR identifies sufficient information for the operator billing system to charge the content provider for the transmission of the content using the MBMS broadcast service (e.g., Content Provider Id, List of Downstream Nodes, List of Traffic Data Volumes, Bearer Service Description, and MBMS Session Identity). Further, the BMSC can act as a Charging Trigger Function and may use the Rf interface to generate accounting information to a Charging Data Function which may create offline charging CDRs. For online charging the BMSC may use the Ro interface create Charging and Credit Request (CCR) information to an On-line Charging System (OCS). The Ro and Rf interfaces are described in 3GPP TS 32.240 V9.1.0 (2010-06).

When the point-to-point connection for the file repair is established via the EPS, a Packet Data Network Gateway node (P-GW) generates a CDR for point-to-point connection. This CDR identifies sufficient information for the operator billing system to charge the subscriber for the transmission of the content associated with the file repair procedure (e.g., Subscriber Id, List of Service Data including traffic volumes categorized by rating group or rating group/service identifier). However, the CDRs of the P-GW do not allow for associating the CDR with an eMBMS/MBMS service or even an eMBMS/MBMS session instance.

Thus, in summary, MBMS provides charging records for the operator to charge the content provider for the transmission of the broadcast. When the MBMS download service is used for a broadcast, when a user device receives portions of the broadcast in error, there is an optional associated file repair procedure invoked using a point-to-point (unicast) connection to the Broadcast-Multicast Service Center (BM-SC).

With the Policy and Charging Control architecture as standardized by 3GPP in TS 23.203 V12.3.0, it is possible to provision the P-GW with rules that allow the traffic counts specific to the file repair service to be categorized by rating group or rating group/service identifier.

However, it is not currently possible to charge the content provider for transmission via the file repair procedure of the corrected portion of the content data.

Consequently, it is a problem that there is no ability to identify which broadcast event or content provider the file repair traffic is associated with in order to charge for the transmission of data associated therewith.

### SUMMARY

It is an object of the invention to provide a method, media service controller and computer program product for data repair in a data communication network providing the ability to identify which broadcast event or content provider a data repair traffic is associated with in order to charge for the transmission of data associated therewith, for example towards a content provider.

A first aspect of the invention relates to a method for data repair performed by a media service controller. The method includes receiving a data repair request including a data identifier from a user device for establishing a data repair session for the data and finding a content provider identity based on the data identifier received with the data repair request message. The method further includes sending an authorization request including the content provider identity and a flow description to a policy rules function and in response to an authorization response from the policy rules function continuing the data repair session by commencing the data repair data transmission.

An advantage with the invention is that the operator can generate comprehensive traffic usage reporting data for a broadcast event thereby enabling charging, for example towards a content provider or other sponsor of the traffic, and subsequent traffic analysis for provisioning and maintenance of broadcast network components.

A second aspect of the invention relates a media service controller for data repair comprising a processor circuitry and a memory. The memory is containing instructions that, when executed by the processor circuitry, cause the media service controller to receive a data repair request including a data identifier from a user device for establishing a data repair session for the data, and to find a content provider identity based on the data identifier received with the data repair request message. The memory is further containing instructions that, when executed by the processor circuitry, cause the media service controller to

send an authorization request including the content provider identity and a flow description to a policy rules function; and in response to an authorization response from the policy rules function continue the data repair session by commencing the data repair data transmission.

A third aspect of the invention relates a media service controller adapted to receive a data repair request including a data identifier from a user device for establishing a data repair session for the data and to find a content provider identity based on the data identifier received with the data repair request message. The media service controller is further adapted to send an authorization request including the content provider identity and a flow description to a policy rules function; and in response to an authorization response from the policy rules function continue the data repair session by commencing the data repair data transmission.

A fourth aspect relates to a computer program product comprising a non-transitory computer readable medium and a computer program stored on the computer readable medium.

The computer program comprises computer readable code means, which when run in a computer being configured as a media service controller for data repair, causes the computer to receive a data repair request including a data identifier from a user device for establishing a data repair session for the data, and to find a content provider identity based on the data identifier received with the data repair request message. The computer program further causes the computer to send an authorization request including the content provider identity and a flow description to a policy rules function; and in response to an authorization response from the policy rules function continuing the data repair session by commencing the data repair data transmission.

Embodiments of the invention will now be described in more detail with reference to the enclosed drawings.

### BRIEF DESCRIPTION OF THE DRAWINGS

FIG. 1 is a block diagram showing the architecture of a Multimedia Broadcast Multicast Services architecture supporting file repair.

FIG. 2 is a sequence diagram showing the signaling for charging of a file repair session in an MBMS data network.

FIG. 3 is a flowchart showing a method file repair performed by a media service controller.

FIG. 4 is a block diagram showing an exemplary computing environment for implementing a media service controller for file repair.

FIG. 5 shows a computer program product including a computer program according to the invention.

### DETAILED DESCRIPTION

The following detailed description of the exemplary embodiments refers to the accompanying drawings. The same reference numbers in different drawings identify the same or similar elements. Also, the following detailed description does not limit the present solution.

In particular, in the following description the data to be repaired will be exemplified as being in the form of a file, i.e. a computer file suitable for storing information. However, data to be repaired may constitute any type of media or data storage format.

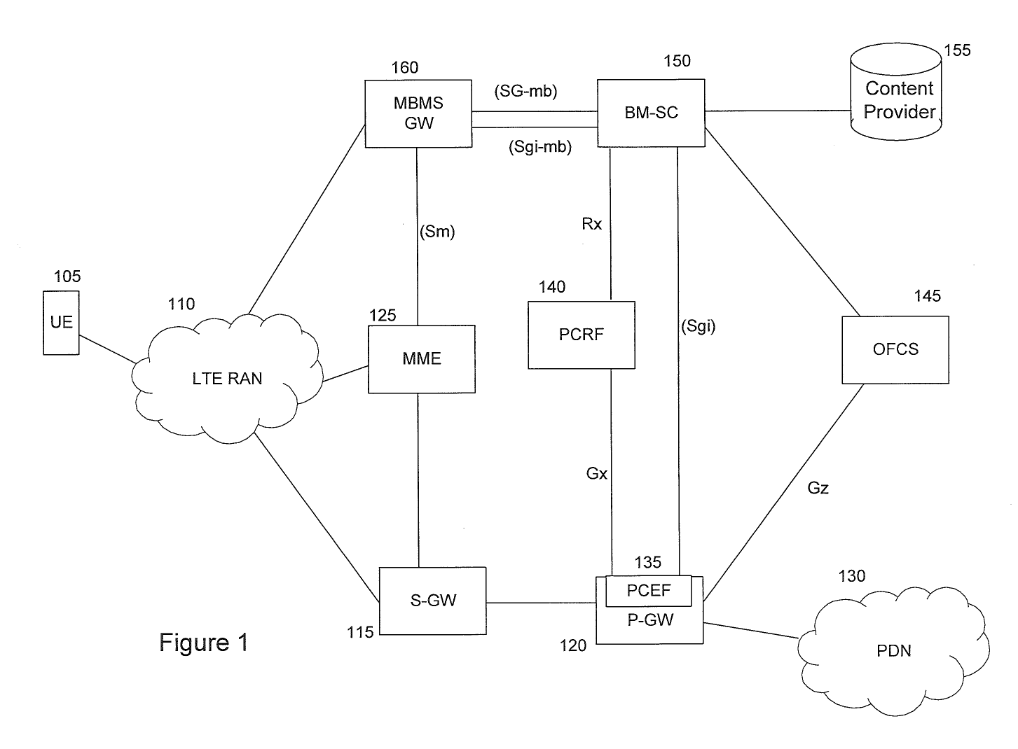

FIG. 1 is a block diagram showing the architecture of a Multimedia Broadcast Multicast Services architecture supporting file repair.

FIG. 1 includes a basic architecture of the EPS wherein this example a UE 105 is connected to an Evolved Packet Core (EPC) over a LTE radio access network 110. In this figure, the EPC is composed of four network elements: the Serving Gateway (S-GW) 115, the PDN Gateway (P-GW) 120 and a Mobility Management Entity (MME) 125. The EPC is connected to an external Packet Data Network (PDN) 130.

The MME deals with the control plane and handles the signaling related to mobility and security for E-UTRAN access.

The gateways (Serving GW and PDN GW) deal with the user plane and transports IP data traffic between the User Equipment (UE) and the external PDN. The Serving GW 115 is the anchor point for the intra-LTE mobility (i.e. handover between eNodeBs) and between LTE and other 3GPP accesses and is logically connected to the P-GW.

The P-GW 120 is the point of interconnect between the EPC and the external PDN 130. The P-GW routes packets to and from the PDNs and also performs various functions such Policy Control and Charging (PCC).

The PCC functionality is comprised by the functions of a Policy and Charging Enforcement Function (PCEF) 135, a Policy and Charging Rules Function (PCRF) 140, and the Offline Charging System (OFCS) 145.

The PCC architecture extends the architecture of an IP Connectivity Access Network IP-CAN, e.g. General Packet Radio Services (GPRS) or EPC, where the PCEF is a functional entity in the gateway node, e.g. P-GW 120, implementing the IP access to the PDN 130.

The PCRF is the part of the network architecture that aggregates information to and from the network supporting the creation of rules and then making policy decisions for subscribers active on the network.

A Gx interface point connects the PCEF and the PCRF and enables a PCRF to have dynamic control over the PCC behavior at a PCEF. The Gx interface thus enables the signaling of PCC decisions, which governs the PCC behavior.

The Gz interface connects the PCEF and the OFCS and enables transport of service data flow based offline charging information.

In the MBMS, a BM-SC 150 provides functions for MBMS user service provisioning and delivery. It may serve as an entry point for a Content Provider 155 MBMS transmissions, used to authorize and initiate MBMS Bearer Services within the mobile network and can be used to schedule and deliver MBMS transmissions.

The network may include one or more MBMS Gateways (MBMS-GW) 160 functional entities. An MBMS-GW may be stand alone or co-located with other network elements such as BM-SC or combined S-GW/P-GW. The MBMS-GW provides an interface for entities using MBMS bearers through the SGi-mb (user plane) interface and further provides an interface for entities using MBMS bearers through the SG-mb (control plane) interface.

The BM-SC and MBMS-GW may thereby act as a dedicated packet network for broadcast data, connected to the RAN.

The MBMS control plane function is supported by the MME 125 for E-UTRAN access and by a Serving GPRS Support Node (SGSN) for UTRAN access.

The introduction of an interface between the BM-SC, or more specifically a BMSC Associated Delivery Function (BMSC-ADF), and the Policy and Charging Rules Function (PCRF) serving the EPS enables the BM-SC to authorize a specific data flow and associate a Content Provider 155 with that specific data flow.

The Rx interface specified in TS 29.214 V12.2.0 utilizing a capability known as Sponsored Connectivity may be used for this interface. The Rx interface connects an Application Function (AF) and the PCRF and enables enables transport of application level session information from an AF to PCRF.

Utilizing Sponsored Connectivity capability, when the BM-SC receives a request from the user device to establish a file repair session, the BM-SC initiates an Rx session with the PCRF to authorize and sponsor the service data flow, which may be identified by remote and local IP addresses combined with remote and local ports, and provides the Content Service Provider Id (CSP-ID) and/or a Sponsor Identity to allow the sponsor to be separate from the content provider.

This information is delivered as part of the PCC rules delivered to the P-GW resulting in a set of traffic measurement counts categorized by the specified CSP-ID to be included in the CDR generated by the P-GW.

The file repair service may thereby use an SGi interface between the BM-SC and the P-GW, i.e. the requested correct data does not need to pass via MBMS-GW but instead from BM-SC to P-GW over SGi.

This allows the operator billing system to separate the traffic usage incurred by the subscriber and charge this usage directly to the content provider for the specific broadcast event. The presence of CDR fields for sponsor identity and content service provider identity may then invokes sponsorship when the CDR is processed in the charging domain. These values tell what kind of sponsorship should be applied. Due to the optional inclusion of both a sponsor identity and content service provider identity, the sponsoring of the file repair may thereby be directed towards a third party other than the content provider.

The BMSC-ADF function needs to find the associated CSP-ID based on the file Uniform Resource Identifier (URI) received with the file repair request message. In order to do that, the BM-SC may maintain a table, which associates file URIs to CSP-IDs.

In case of content provider charging, the BMSC-ADF may first need to authenticate and authorize the UE for using the “Content-Provider Charged File Repair procedure”.

In case of end-user paid services, the new procedure may include to only indicate that data transfer relates to eMBMS, so that the P-GW marks the CDR of the file repair related flows accordingly.

There may be several BMSC-ADF functions in the system. The number of ADF functions and its IP addresses may change over time according to the file repair and reception reporting load. Since the number of ADF functions may change over time dynamically, maintaining a direct per file repair session allows for the PCRF to provide specific dynamically created rules to the P-GW, so that File Repair traffic can be easily charged directly to the content provider, if desired.

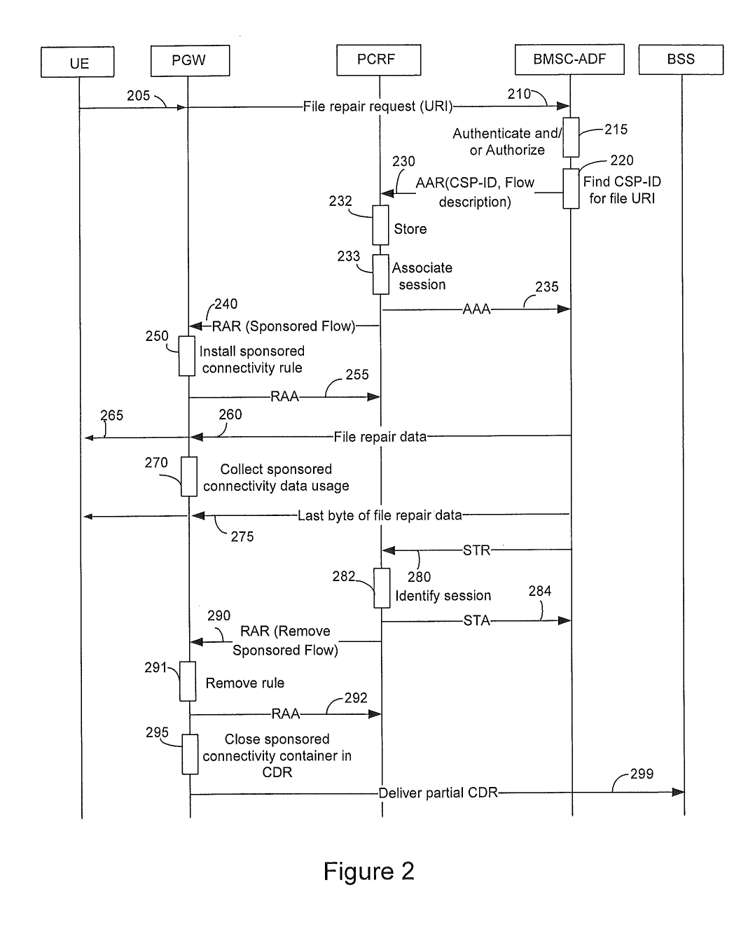

FIG. 2 is a sequence diagram showing the signaling for charging of a file repair session in an MBMS data network.

In step 205 the UE initiates a file repair procedure by initiating a request. The request includes the file Uniform Resource Locator (URI) of the file to be repaired.

The BMSC-ADF receives the file repair request in step 210.

In case of content provider charging, the BMSC-ADF may first need to authenticate and authorize the UE for using the “Content-Provider Charged File Repair procedure” in a step 215.

In step 220 it is determined that the data transfer of the file repair should be charged to the content provider rather than to the user's regular data plan. The BM-SC maintains a database, e.g. a table, which associates file URIs to CSP-IDs for this purpose. Using this database, the CSP-ID is found based on the received file URI.

In step 230 the BM-SC requests sponsored connectivity for the File Repair data flow from the PCRF. This may be done using the Application Function (AF) session establishment procedure defined in TS 29.213 V12.2.0 chapter 4.3.1.2.1 by sending a Diameter Authorization-Authentication-Request (AAR) message to the PCRF. The AAR is sent from the BM-SC in order to provide the PCRF with session information and includes the CSP-ID and a Flow Description. The CSP-ID may be an arbitrary identifier assigned by the operator to the content provider. The Flow Description may be an Internet Protocol (IP) tuple made up of source IP address, destination IP address, source port number, destination port number and a protocol descriptor for the protocol in use.

The source IP address and port may be retrieved from the IP header information in the outbound TCP message from the BMSC while the destination IP address and port maybe retrieved from the incoming TCP message from the UE.

The AAR may also include optionally include a Charging Identifier (CID). The charging identifier may be a globally unique identifier generated by the BMSC for a specific download session. It would be transmitted via a PCRF to a PGW for the CDR and would be the key to a CDR generated at the BMSC in order to add specific information about the file repair. These two records could then be combined in the end for a complete multi-level view of the session.

Further, the AAR may include a content identifier. The content identifier may for example be related to an URI. For example, there could be multiple files associated with some particular content (identified by the content id). Then, in order to broadcast each file, it is further divided into segments which may be augmented with forward error correction data. Each of these segments may then have an URI associated with it. When a file repair procedure is done, the UE is requesting the set of segments that were received corrupted (or not received at all). The content identifier may then be delivered to the PCRF for inclusion in the CDR. The CDR may then be correlated to a corresponding charging event in the BMSC such that, if the operator desired, a bill could reflect not just that a specific customer had a file repair service, but that it was specifically for a particular content.

The PCRF stores the received session information in step 232.

In step 233 the BM-SC session is associated with a sponsor by the PCRF using the CSP-ID and the Flow Description and the request is authorized. The PCRF identifies the affected established IP-CAN Session(s) using the CSP-ID and the Flow Description.

In step 235 a Diameter Authorization-Authentication-Answer (AAA) message is sent by the PCRF to the BM-SC in response to the AAR message.

Once authorized, The PCRF, in turn, invokes an IP-CAN session modification procedure in step 240 by sending a Re-Auth-Request (RAR) command to the PGW. The RAR will include a Sponsored Flow parameter.

A sponsored connectivity rule is installed in the PGW in step 250, such that all data usage collected for traffic matching the IP flow description provided by the BMSC-ADF will be collected into a special container identified by the Content Provider ID. The data usage is associated with the received CID in order to allow later correlation.

In step 255 the PGW sends a Re-Authorization-Answer (RAA).

File repair data is then sent from the BM-SC to the PGW in step 260, and further on to the UE in step 265. The file repair data may be retrieved from the content database or it may have been cached by the BMSC during the broadcast or multicast.

The PGW collects sponsored data usage in step 270:

When the BMSC-ADF completes the file repair procedure in step 275, the sponsored connectivity request is terminated using the AF session termination procedure defined in TS 29.213 by sending a Diameter Session-Termination-Request (STR) message to the PCRF in step 280.

The PCRF identifies the affected IP-CAN Session where PCC Rules and, if available, QoS Rules for the IP flow(s) of this BM-SC session are installed in step 282 in order to remove these rules.

In step 284 the PCRF sends Diameter, Session Termination Answer (STA), to the BM-SC.

The PCRF, in turn, invokes the IP Connectivity Access Network (IP-CAN) session modification procedure to uninstall the sponsored connectivity rule in steps 290-291-292 similar to steps 240-250-255 previously described.

The PGW will then close the sponsored connectivity container in step 295 and send a partial CDR to an Offline Charging System (OFCS) or Business Support System (BSS) domain for processor in step 299.

For CSP paid file repair the CDR may thus include data specifying the data traffic associated with the file repair including an identifier of the content provider, e.g. the CSP-ID. In case of end-user paid services, the P-GW may mark the CDR of the file repair related flows the indicating “eMBMS”, so that the end user may be charged accordingly.

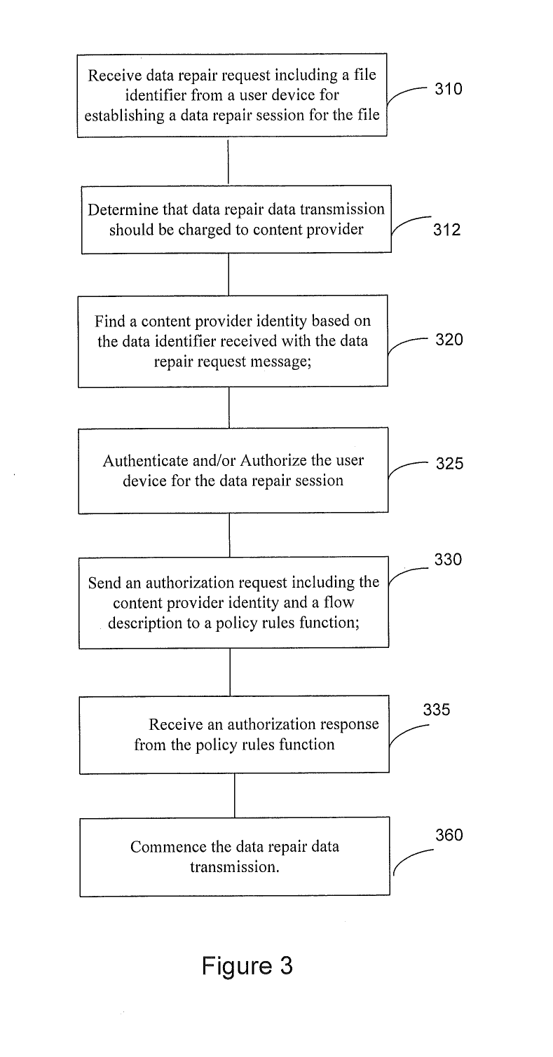

FIG. 3 is a flowchart showing a method for data repair performed by a media service controller.

The data to be repaired may constitute any type of media or data storage format. In the following, the data to be repaired is exemplified as being in the form of a file, i.e. a computer file suitable for storing information.

A file repair request including a file identifier such as a URI, from a user device for establishing a file repair session for the file is received by the media service controller, such as a BMSC, in step 310. The media service controller may determine that the file repair data transmission should be charged to the content provider in step 312.

In step 320 the media service controller finds a content provider identity based on the file identifier received with the file repair request message. Step 320 may further comprise finding the content provider identity by accessing a database which associates the file identifier with a corresponding content provider identity.

The media control server may authenticate and/or authorize the user device for the file repair session.

An authorization request is sent in step 330 and includes the content provider identity and a flow description to a policy rules function.

In response to an authorization response from the policy rules function in step 335 the media service controller continues the file repair session by commencing the file repair data transmission in step 360. The authorization request may comprise a Diameter AAR message including a request for sponsored connectivity.

The media service controller may maintain a session towards the policy rules function to authorize and recognize the file repair data transmission.

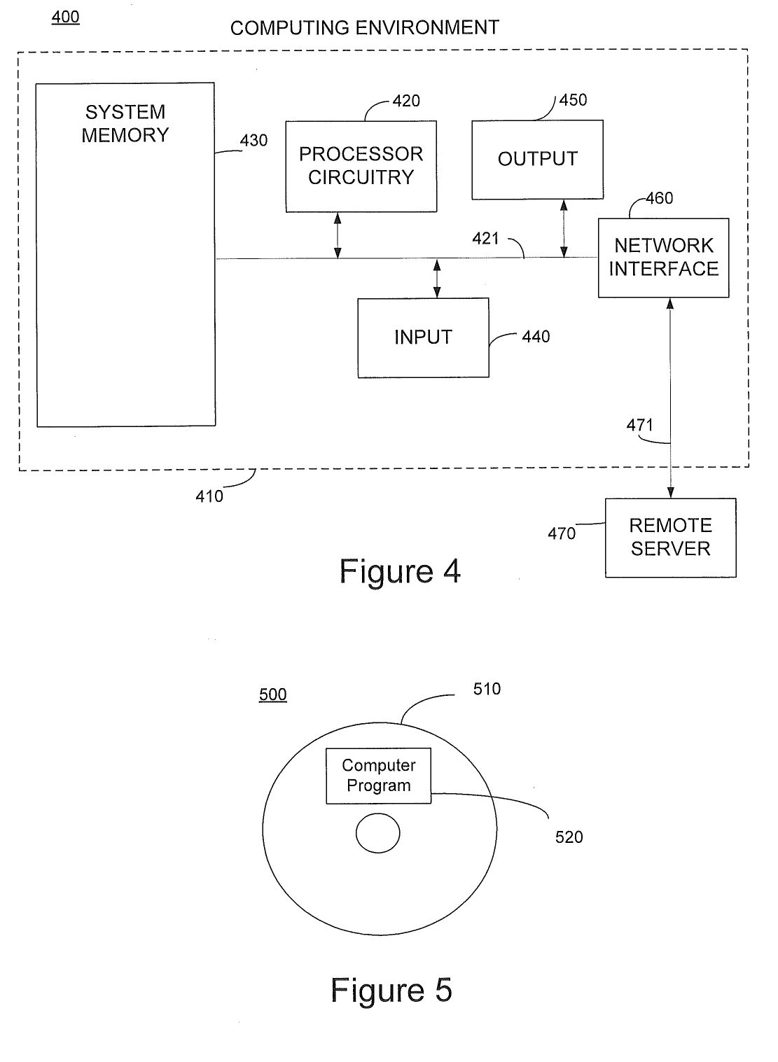

FIG. 4 is a block diagram showing an exemplary computing environment for implementing a media service controller for file repair.

Although as made clear above, the computing system environment 400 is only one example of a suitable computing environment for an involved system node such as the media service controller and is not intended to suggest any limitation as to the scope of use or functionality of the claimed subject matter. Further, the computing environment 400 is not intended to suggest any dependency or requirement relating to the claimed subject matter and any one or combination of components illustrated in the example operating environment 400.

The media service controller for file repair includes a general purpose computing device in the form of a computer 410. Components of computer 410 can include, but are not limited to, a processor circuitry 420, a system memory 430, and a system bus 421 that couples various system components including the system memory to the processor circuitry 420. The system bus 421 can be any of several types of bus structures including a memory bus or memory controller, a peripheral bus, and a local bus using any of a variety of bus architectures.

Computer 410 can include a variety of transitory and non-transitory computer readable media. Computer readable media can be any available media that can be accessed by computer 410. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules, program units or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 410.

Communication media can embody computer readable instructions, data structures, program modules or other data in a modulated data signal such as a carrier wave or other transport mechanism and can include any suitable information delivery media.

The system memory 430 can include computer storage media in the form of volatile and/or nonvolatile memory such as read only memory (ROM) and/or random access memory (RAM). A basic input/output system (BIOS), containing the basic routines that help to transfer information between elements within computer 410, such as during start-up, can be stored in memory 430. Memory 430 can also contain data and/or program modules that are immediately accessible to and/or presently being operated on by processor circuitry 420. By way of non-limiting example, memory 430 can also include an operating system, application programs, other program modules, and program data.

The system memory 430 may contain instructions loaded in the memory and processable by the processor circuitry, or other circuitry, capable of adapting the computer for performing the steps of the media service controller according to the disclosed solution.

As an example, the instructions may be adapting the computer 410 into a media service controller for file repair.

The instructions may, when executed by the processor circuitry cause the computer to receive a data repair request including a data identifier from a user device for establishing a data repair session for the data, and to find a content provider identity based on the data identifier received with the data repair request message. The computer program further causes the computer to send an authorization request including the content provider identity and a flow description to a policy rules function; and in response to an authorization response from the policy rules function continuing the data repair session by commencing the data repair data transmission.

The computer 410 can also include other removable/non-removable and volatile/nonvolatile computer storage media. For example, computer 410 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 421 through a non-removable memory interface such as an interface, and a magnetic disk drive or optical disk drive can be connected to the system bus 421 by a removable memory interface, such as an interface.

A user can enter commands and information into the computer 410 through input devices such as a keyboard or a pointing device such as a mouse, trackball, touch pad, and/or other pointing device. Other input devices can include a microphone, joystick, game pad, satellite dish, scanner, or similar devices. These and/or other input devices can be connected to the processor circuitry 420 through user input 440 and associated interface(s) that are coupled to the system bus 421, but can be connected by other interface and bus structures, such as a parallel port, game port or a universal serial bus (USB).

A graphics subsystem can also be connected to the system bus 421. In addition, a monitor or other type of display device can be connected to the system bus 421 through an interface, such as output interface 450, which can in turn communicate with video memory. In addition to a monitor, computers can also include other peripheral output devices, such as speakers and/or printing devices, which can also be connected through output interface 450.

The computer 410 can operate in a networked or distributed environment using logical connections to one or more other remote computers, such as remote server 470, which can in turn have media capabilities different from device 410. The remote server 470 can be a personal computer, a server, a router, a network PC, a peer device or other common network node, and/or any other remote media consumption or transmission device, and can include any or all of the elements described above relative to the computer 410. The logical connections depicted in FIG. 4 include a network 471, such as a local area network (LAN) or a wide area network (WAN), but can also include other networks/buses.

When used in a LAN networking environment, the computer 410 is connected to the LAN 471 through a network interface or adapter 460. When used in a WAN networking environment, the computer 410 can include a communications component, such as a modem, or other means for establishing communications over a WAN, such as the Internet. A communications component, such as a modem, which can be internal or external, can be connected to the system bus 421 through the user input interface at input 440 and/or other appropriate mechanism.

In a networked environment, program modules depicted relative to the computer 410, or portions thereof, can be stored in a remote memory storage device. It should be noted that the network connections shown and described are exemplary and other means of establishing a communications link between the computers can be used.

Further possible embodiments will now be briefly described:

(i). One example embodiment relates to a media service controller adapted to:
receive a data repair request including a data identifier from a user device for establishing a data repair session for the data, find a content provider identity based on the data identifier received with the data repair request message; send an authorization request including the content provider identity and a flow description to a policy rules function; and
in response to an authorization response from the policy rules function continue the data repair session by commencing the data repair data transmission.

(ii). The example media service controller according to paragraph (i) may be further adapted to determine that the data repair data transmission should be charged to the content provider.

(iii). The example media service controller according to any one of paragraphs (i) or (ii) may be further adapted to find the content provider identity by accessing a database which associates the data identifier with a corresponding content provider identity.

(iv). The example media service controller according to any one of paragraphs (i)-(iii) may be further adapted to authenticate and/or authorize the user device for the data repair session.

(v). The example media service controller according to any one of paragraphs (i)-(iv) may be further adapted to maintain a separate session towards the policy rules function to authorize and recognize the data repair data transmission.

(vi). The example media service controller according to any one of paragraphs (i)-(v) may comprise a Broadcast Multicast Service Center.

(vii). The data identifier in the example media service controller according to any one of paragraphs (i)-(vi) may comprise a Uniform Resource Identifier.

(viii). The authorization request in the example media service controller according to any one of paragraphs (i)-(vii) may comprise a Diameter AAR message including a request for sponsored connectivity.

Additionally, it should be noted that as used in this application, terms such as “component,” “display,” “interface,” and other similar terms are intended to refer to a computing device, either hardware, a combination of hardware and software, software, or software in execution as applied to a computing device. For example, a component may be, but is not limited to being, a process running on a processor circuitry, a processor, an object, an executable, a thread of execution, a program and a computing device. As an example, both an application running on a computing device and the computing device can be components. One or more components can reside within a process and/or thread of execution and a component can be localized on one computing device and/or distributed between two or more computing devices, and/or communicatively connected modules. Further, it should be noted that as used in this application, terms such as “system user,” “user,” and similar terms are intended to refer to the person operating the computing device referenced above.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various exemplary combinations and subcombinations of embodiments and of the manner and process of making and using them, and shall support claims to any such combination or subcombination.

Many variations and modifications can be made to the embodiments without substantially departing from the principles of the present solution. All such variations and modifications are intended to be included herein within the scope of the present solution.

1. A method for data repair performed by a media service controller, the method comprising the steps of:
receiving a data repair request including a data identifier from a user device for establishing a data repair session for the data,
finding a content provider identity based on the data identifier received with the data repair request message;
sending an authorization request including the content provider identity and a flow description to a policy rules function; and
in response to an authorization response from the policy rules function continuing the data repair session by commencing the data repair data transmission.

2. The method according to claim 1 comprising, before the step of finding, performing the further step of determining that the data repair data transmission should be charged to the content provider.

3. The method according to claim 1 wherein the step of finding further comprises finding the content provider identity by accessing a database which associates the data identifier with a corresponding content provider identity.

4. The method according to claim 1 comprising, before the step of sending the authorization request the further step of authenticating and/or authorizing the user device for the data repair session.

5. The method according to claim 1 wherein the media service controller is maintaining a separate session towards the policy rules function to authorize and recognize the data repair data transmission.

6. The method according to claim 1 wherein the media services controller comprises a Broadcast Multicast Service Center.

7. The method according to claim 1 wherein the data identifier comprises a Uniform Resource Identifier.

8. The method according to claim 1 wherein the authorization request comprises a Diameter AAR message including a request for sponsored connectivity.

9. A media service controller for data repair comprising:
a processor circuitry;
a memory containing instructions that, when executed by the processor circuitry, cause the media service controller to:
receive a data repair request including a data identifier from a user device for establishing a data repair session for the data,
find a content provider identity based on the data identifier received with the data repair request message;
send an authorization request including the content provider identity and a flow description to a policy rules function; and
in response to an authorization response from the policy rules function continue the data repair session by commencing the data repair data transmission.

10. The media service controller according to claim 9 wherein the memory is further containing instructions that, when executed by the processor circuitry, cause the media service controller to determine that the data repair data transmission should be charged to the content provider.

11. The media service controller according to claim 9 wherein the memory is further containing instructions that, when executed by the processor circuitry, cause the media service controller to find the content provider identity by accessing a database which associates the data identifier with a corresponding content provider identity.

12. The media service controller according to claim 9 wherein the memory is further containing instructions that, when executed by the processor circuitry, cause the media service controller to authenticate and/or authorize the user device for the data repair session.

13. The media service controller according to claim 9 wherein the memory is further containing instructions that, when executed by the processor circuitry, cause the media service controller to maintain a separate session towards the policy rules function to authorize and recognize the data repair data transmission.

14. The media service controller according to claim 9 wherein the media services controller comprises a Broadcast Multicast Service Center.

15. The media service controller according to claim 9 wherein the data identifier comprises a Uniform Resource Identifier.

16. The media service controller according to claim 9 wherein the authorization request comprises a Diameter AAR message including a request for sponsored connectivity.

17. A computer program product, comprising a non-transitory computer readable medium and a computer program stored on the computer readable medium, the computer program comprising computer readable code, which when run in a computer being configured as a media service controller for data repair, causes the computer to perform the following steps:
receiving a data repair request including a data identifier from a user device for establishing a data repair session for the data,
finding a content provider identity based on the data identifier received with the data repair request message;
sending an authorization request including the content provider identity and a flow description to a policy rules function; and
in response to an authorization response from the policy rules function continuing the data repair session by commencing the data repair data transmission.
